(19) United States
(12) Patent Application Publication
(10) Pub. No.: US 2007/0236307 A1
(43) Pub. Date: Oct. 11, 2007

(54) Methods and apparatus for a packaged MEMS switch

(76) Inventor: Lianjun Liu, Gilbert, AZ (US)

Correspondence Address: INGRASSIA FISHER & LORENZ, P.C. (FS), 7150 E. CAMELBACK ROAD, SUITE 325, SCOTTSDALE, AZ, 85251, US

(21) Appl. No.: 11/401,797

(22) Filed: Apr. 10, 2006

(51) Int. Cl. H01P 1/10

(52) U.S. Cl. 333/105

(57) ABSTRACT

A micro-electro mechanical system (NEMS) device, such as a MEMS switch (100), includes a package seal (104) bonded to a substrate (102), wherein an electrode 106 (e.g., an actuation electrode associated with a switch) is provided on an inner surface (103) of the package seal (104). The MEMS switch (100) might include, for example, a central switch structure implementing a double-pole, single-throw switch using a push-pull arrangement of internal activation electrodes (106, 108). The central switch structure might include a cantilevered moveable actuation electrode (122) or an electrode supported in two or more peripheral regions.

### TECHNICAL FIELD

The present invention relates generally to micro-electromechanical systems (MEMS) and, more particularly, to an improved MEMS switch structure.

### BACKGROUND

Micro-electromechanical systems (MEMS) technology has achieved wide popularity in recent years, as it provides a way to make very small mechanical structures using conventional batch semiconductor processing techniques. One such device is the MEMS switch, which typically includes some form of internal switch structure actuated by an externally-applied voltage that causes an internal electrostatic potential between components of the structure. MEMS switches are used in a wide variety of applications, including tunable RF systems, wireless handsets, band switching systems, voltage controlled oscillators (VCOs), filters, and the like.

Functionally, MEMS switches may take many forms, including single-pole/single-throw (SPST), single-pole/double throw (SPDT), and the like. SPDT switches are typically constructed by building two SPST switches side-by-side. Such designs are unnecessarily bulky, as they utilize approximately twice the volume of common SPSP MEMS switches.

Furthermore, it is common to fabricate the MEMS switch first, then seal the switch in a larger enclosing package. This practice requires additional processing steps (switch fabrication followed by packaging) and results in a device that is significantly larger than the MEMS switch itself, particularly in the case of SPDT switches.

Accordingly, it is desirable to provide improved MEMS switch structures that are compact, efficient, and manufacturable. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a cross-sectional overview of a MEMS switch in accordance with one embodiment;

FIG. 2 is a cross-sectional overview of a MEMS switch in accordance with an alternate embodiment; and

FIG. 3 is a simplified isometric overview of an exemplary shorting bar and transmission line.

### DETAILED DESCRIPTION

The following detailed description is merely illustrative in nature and is not intended to limit the scope or application of possible embodiments. Furthermore, there is no intention to be bound by any expressed or implied theory presented in the preceding technical field, background, brief summary or the following detailed description.

Various embodiments may be described herein in terms of functional and/or logical block components and various processing steps. It should be appreciated that such block components may be realized by any number of hardware, software, and/or firmware components configured to perform the specified functions. For the sake of brevity, conventional techniques related to semiconductor processing, MEMS processing, and switch technology are not described herein.

In general, a MEMS switch in accordance with one embodiment incorporates one or more electrodes on the interior surface of the MEMS package itself—for example, on the underside of package seal or “cap” —such that one “throw” of the switch is incorporated into the cap, thereby reducing the overall size of the device. Referring to the cross-sectional overview shown in FIG. 1, an exemplary MEMS switch in accordance with one embodiment will now be described. As a preliminary matter, it should be noted the figures are not intended to be scale drawings, and that the relative dimensions of layers and spacing as shown are merely to assist with illustrating the embodiments conceptually.

As shown in FIG. 1, a MEMS switch 100 includes a substrate 102 (e.g., a semiconductor substrate or the like) and a package seal (or “cap”) 104 mechanically coupled to substrate 102 such that package seal 104 helps protect interior components. A central switch component (or simply “switch component”) 150 includes a moveable actuation electrode (or “central electrode”) 122 and one or more dielectric mechanical layers—e.g., a first dielectric mechanical layer 120 and a second dielectric mechanical layer 118.

The central switch component 150 has a proximal end 130 mechanically coupled or anchored (directly or indirectly) to substrate 102, and a distal end 132. Switch component 150 as illustrated in FIG. 1 is thus a cantilever structure (or other suspended microstructure) wherein layers 118 and 120 and moveable activation electrode 122 are capable of bending such that distal end 132 experiences up-and-down movement with respect to the orientation shown in FIG. 1.

The static and dynamic properties of the cantilever structure (e.g., the effective spring constant of the structure) may be specified given the various constituent layers using standard mechanical methods known in the art (e.g., empirical methods, finite-element modeling, closed-form calculations, or the like). In exemplary embodiments, central dielectric layers 118 and 120 each have a thickness ranging from about 100 Å and 10 microns. The length of structure 150 (i.e., left to right in FIG. 1) may be one the order of 10-900 microns. In one embodiment, the width of structure 150 (i.e., perpendicular to the length) is greater than the length. It will be appreciated that the invention is not so limited, however, and that structure 150 may have any desired dimensions and shape (e.g., rectilinear, curvilinear, or a combination thereof).

Package seal 104 generally includes a topmost sealing layer 105 having an interior surface 103. A top actuation electrode (or simply “electrode”) 106 and a top RF transmission line contact (or simply “contact”) 110 are suitably provided on inner surface 103. Similarly, in the SPDT embodiment, a bottom actuation electrode 108 and a bottom RF transmission line contact 112 are provided on substrate 102 generally opposite electrode 106 and contact 110 on surface 103.

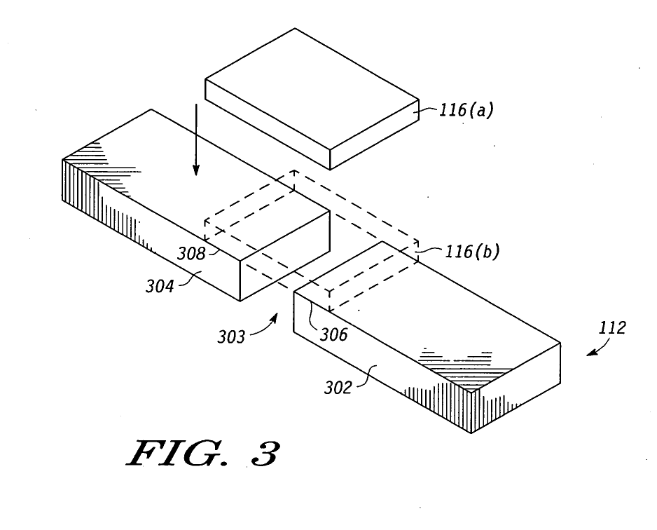

One or more conductive “shorting bars” 114 and 116 are provided at distal end 132 of switch structure 150. As shown, shorting bar 114 generally faces transmission line contact 110, and shorting bar 116 generally faces transmission line contact 112. In this regard, the shorting bars function to form a continuous conductive path along respective transmission lines. More particularly, referring briefly to FIG. 3, transmission line 112 includes two portions 304 and 302 separated by a gap 303. Shorting bar 116 has a position 116(a) when the switch is in a rest state, but moves downward and contacts regions 306 and 308 of transmission line 112 when in an actuated state. The signal traveling through transmission line 112 may be any suitable electrical signal, for example, a signal within the range of DC to 100 GHz. In one embodiment, the signal is within the range of 800 MHz to 2.5 GHz. In an alternate embodiment, high frequencies (e.g., greater than 50 GHz) may be used.

Referring again to FIG. 1, when an appropriate bias voltage is applied to electrode 106 or electrode 108 with respect to middle electrode 122 (which may be electrically connected to ground), an electrostatic potential is induced between electrodes, and the switch is activated in one of two positions (i.e., one of two “throws”). One throw corresponds to the case where shorting bar 116 contacts transmission line 112, and the second throw corresponds to the case where shorting bar 114 contacts transmission line 110. Note that shorting bars 114 and 116 may themselves be electrically continuous without degrading performance of the system.

The voltage at which the switch is actuated will vary depending on materials, geometry, component spacing, electrode area, and the like as known in the art. In an exemplary embodiment, a DC voltage of about 10 volts to 50 volts is applied to electrode 106 or electrode 108 (with respect to a grounded central electrode 122) in order to generate the necessary electrostatic force to actuate the switch. It will be understood, however, that the invention is not so limited. The actuation voltage may be DC, AC, or have any arbitrary waveshape suitable for the application. Similarly, the voltage may be negative or positive.

It will be understood that various electrical interconnects (e.g., signal lines) will extend from nodes outside of device 100 to electrodes 106, 108, and 122, as well as contacts 110 and 112. This is illustrated conceptually with electrode 122 (shown leading out of the package), as well as electrode 126, which, while not shown, is electrically coupled to electrode 106.

The various contacts, metal traces, electrodes, shorting bars, and transmission lines may be formed from any material or combination of materials, including, for example, aluminum, titanium, chromium, platinum, gold, tungsten, nickel, copper, polysilicon, and the like. In one embodiment, the electrodes are fabricated from aluminum, or polysilicon, and the shorting bars, transmission lines, and metal traces are fabricated from a metal with higher electrical conductivity—e.g., gold or platinum.

Substrate 102 may comprise any suitable material—for example, a ceramic, a glass, a semiconductor (Si, Ge, GaAs, etc.), or any of the various high-resistivity substrates used in connection with RF devices. Dielectric layers may be formed from, for example, silicon dioxide, silicon nitride, silicon oxynitride, or any other suitable dielectric material.

The dimensions of switch structure 150 may be selected to achieve the desired stiffness (k), range, actuation distance, stability, and the like. In one embodiment, for example, electrode 122 has a width (into the page with respect to FIG. 1) ranging from about 0.1 micron to 100 microns, and a length (horizontal distance in FIG. 1) that is less than or equal to its width.

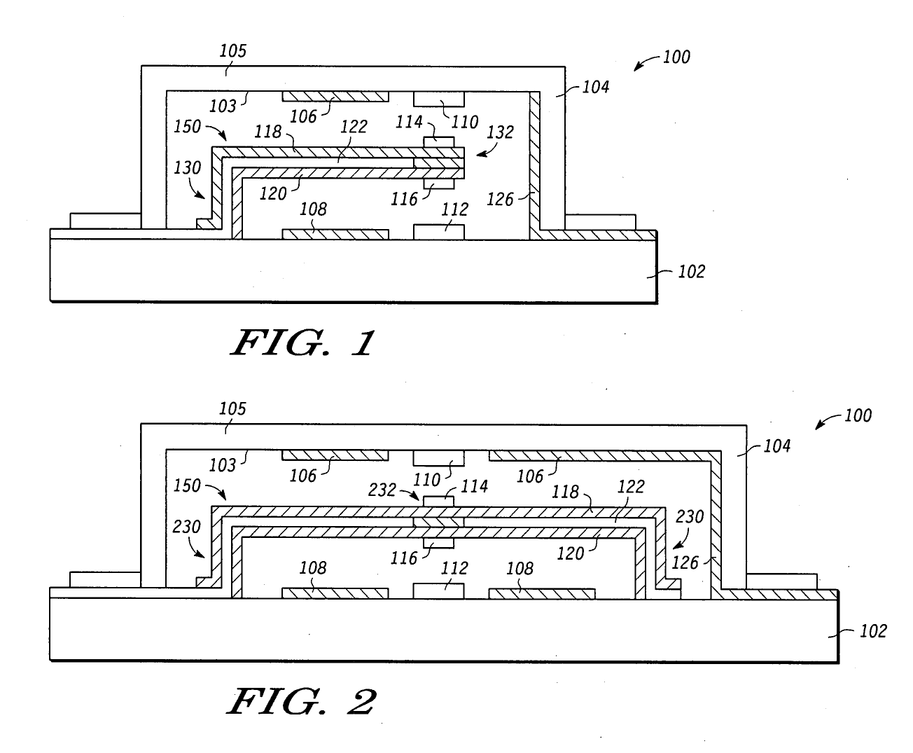

FIG. 2 is a cross-sectional overview of a MEMS switch in accordance with an alternate embodiment of the present invention. In this embodiment, central switch component 150 is not a cantilever structure as shown in FIG. 1, but is rather a structure that is supported at least two places around its perimeter—e.g., in a “bridge” formation. In the illustrated embodiment, switch structure 150 is supported at ends 230. As with the previous embodiment, a suitable voltage is applied to electrodes 106 or electrodes 108 with respect to central electrode 122 (which may be connected to ground). This causes respective shorting bars 114 and 116 to contact respective transmission lines 110 and 112. As with the previous embodiment, by incorporating electrodes 106 on the interior surface of cap 104, the resulting structure is extremely compact.

Having thus given an overview of an example MEMS switch structure, a method of forming the device will now be described with reference to FIGS. 1 and 2. It will be appreciated that the described process may include additional processing steps and might also be just one part of a larger method. Furthermore, while the process steps may be shown as being performed on only a small portion of the substrate, it will be understood that the steps may be performed on multiple devices simultaneously through wafer-level processing. The fabrication of bulk-machined and surface-machined MEMS structures using conventional photolithography, wet and dry etching, oxidation, diffusion, chemical vapor deposition, and sputter deposition techniques is well known, and thus need not be discussed in detail herein.

First, a suitable substrate is provided. As mentioned earlier, substrate 102 may be any suitable material, e.g., a semiconductor wafer or any other conventional substrate material. Bottom actuation electrode 108 and bottom RF transmission line contact 112 are formed on substrate 102, and may have any desired shape. Formation of these structures may be accomplished using any conventional metal deposition technique, followed by standard photoresist deposition and etching.

Next, a sacrificial layer (not shown) is formed over electrode 108 and contact 112. As used in the art, a “sacrificial layer” is a layer of material that is deposited in order to assist in fabrication of the desired structures, but which is removed during subsequent processing. A number of materials are suitable for use as sacrificial layers, including, for example, polyimide, parylene and other polymers, porous silicon, and various dielectrics materials. In one embodiment, for example, a conventional photoresist material is used to form the sacrificial layers.

A conductive layer then deposited on the sacrificial layer and patterned to form shorting bar 116. As mentioned previously, this conductive layer may comprise gold, platinum, aluminum, or any other suitable conductive material deposited in the conventional manner. Shorting bar 116 is preferably formed such that it partially overlaps segmented portions of the corresponding transmission line (see, for example, FIG. 3).

Next, a dielectric mechanical layer 120 is deposited and patterned over shorting bar 116, followed by deposition and patterning of the movable activation electrode 122 (e.g., via deposition of a suitable conductor). A dielectric is then deposited on electrode 122 and patterned to form dielectric mechanical layer 118. Dielectric mechanical layers 120 and 122 may be, for example, silicon dioxide, silicon nitride, or silicon oxy-nitride deposited using conventional CVD techniques. To finish the middle switch structure 132, a conductive layer is deposited and patterned to form shorting bar 114.

Next, a second sacrificial layer (not shown) is deposited over the underlying structures and patterned. This is followed by deposition and patterning of top actuation electrode 106 and top contact 110.

After the inner structures have been formed, a dielectric sealing layer is deposited and patterned. That is, lid 104 is preferably deposited and patterned such that it includes a number of holes or other structures that allow etching of the sacrificial layers within.

Next, the internal sacrificial layers are removed (using, for example, wet or dry etching techniques) to affect structure release. This is followed by deposition of a second dielectric sealing layer that functions to cover the pattern of holes or other patterns etched into the first dielectric sealing layer.

In summary, what has been described, in general, is a MEMS device comprising: a substrate; a package seal coupled to the substrate and having a surface internal to the MEMS device; and a first actuation electrode formed on the surface of the package seal. The device may be a MEMS switch, for example, a single-pole, double-throw switch. Thus, a further embodiment includes a second actuation electrode adjacent the first actuation electrode, wherein the second actuation electrode is a cantilever structure having a proximate end mechanically coupled to the substrate and a distal end moveable with respect to the substrate.

In another embodiment, the MEMS switch includes a third actuation electrode formed on the substrate opposite the first actuation electrode, a first transmission line contact formed on the surface of the package seal, a second transmission line contact formed on the substrate opposite the first transmission line contact, and a shorting bar mechanically coupled to the distal end of the second actuation electrode. In one embodiment, the first actuation electrode and the third actuation electrode are operative in a push-pull manner with respect to the second actuation electrode such that the shorting bar can be selectively brought into contact with the first transmission line contact and the second transmission line contact through the application of a bias voltage to the first and third actuation electrodes. The second actuation electrode may be formed between two dielectric mechanical layers.

In another embodiment, the MEMS device includes a second actuation electrode adjacent the first actuation electrode, wherein the second actuation electrode has a first end mechanically coupled to the substrate, a second end mechanically coupled to the substrate, and a central region moveable with respect to the substrate. Another embodiment includes a third actuation electrode formed on the substrate opposite the first actuation electrode, a first transmission line contact formed on the surface of the package seal, a second transmission line contact formed on the substrate opposite the first transmission line contact, and a shorting bar mechanically coupled to the central region of the second actuation electrode.

The first actuation electrode and the third actuation electrode may be operative in a push-pull manner with respect to the second actuation electrode such that the shorting bar can be selectively brought into contact with the first transmission line contact and the second transmission line contact via application of a bias to the first and third actuation electrodes.

In accordance with another embodiment, a method for forming a MEMS switch device, comprises: providing a substrate; forming a central switch structure on the substrate, the central switch structure including a moveable actuation electrode; forming a top actuation electrode above the moveable actuation electrode; and forming a package seal layer on the stationary actuation electrode.

In a further embodiment, the method includes: forming a bottom actuation electrode and a bottom transmission line contact on the substrate; forming a first sacrificial layer one the bottom actuation electrode and the bottom transmission line contact; forming a top transmission line contact adjacent the top actuation electrode; forming a second sacrificial layer on the central switch structure; forming the top actuation electrode and a top transmission line contact on the second sacrificial layer; forming a first portion of the package seal layer on the top actuation electrode and the top transmission line contact; and removing the first sacrificial layer and the second sacrificial layer. The process may include forming a second portion of the package seal layer after removing the first sacrificial layer and the second sacrificial layer.

In accordance with another embodiment, a MEMS switch comprises: a substrate having a bottom transmission line contact and a bottom activation electrode; a package seal coupled to the substrate and having a top transmission line contact and a top activation electrode; and a central switch structure provided between the substrate and the package seal, wherein the central switch includes a moveable activation electrode and a moveable transmission line contact, and wherein the central switch structure is configured to have a first throw mode and a second throw mode, the first throw mode corresponding to electrical contact between the moveable activation electrode and the first transmission line contact, and the second throw mode corresponding to electrical contact between the moveable activation electrode and the second transmission line contact.

The top actuation electrode and the bottom actuation electrode may be operative in a push-pull manner with respect to the moveable actuation electrode such that the central switch structure can be selectively placed in the first throw mode and the second throw mode via application of a bias to the top and bottom actuation electrodes. In one embodiment, the central switch structure includes at least one dielectric layer mechanically coupled to the moveable actuation electrode. The central switch structure may be a cantilevered structure mechanically coupled to the substrate, or may include a central moveable region and at least two peripheral regions mechanically coupled to the substrate.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A MEMS switch device comprising:
a substrate;
a package seal coupled to the substrate and having a surface internal to the MEMS device; and
a first actuation electrode formed on the surface of the package seal.

2. The device of claim 1, wherein the MEMS switch comprises a single-pole, double-throw switch.

3. The device of claim 1, wherein the MEMS switch further includes:
a second actuation electrode adjacent the first actuation electrode, wherein the second actuation electrode is a cantilever structure having a proximate end mechanically coupled to the substrate and a distal end moveable with respect to the substrate.

4. The device of claim 3, further including a third actuation electrode formed on the substrate opposite the first actuation electrode, a first transmission line contact formed on the surface of the package seal, a second transmission line contact formed on the substrate opposite the first transmission line contact, and a shorting bar mechanically coupled to the distal end of the second actuation electrode.

5. The device of claim 4, wherein the first actuation electrode and the second actuation electrode are operative such that the shorting bar can be selectively brought into contact with the first transmission line contact through the application of a bias voltage across the first and second actuation electrodes.

6. The device of claim 5, wherein the second actuation electrode is formed between two dielectric mechanical layers.

7. The device of claim 5, wherein the second actuation electrode has a length dimension extending laterally along the cantilever structure and a width dimension substantially perpendicular to the length dimension, further wherein the width dimension is greater than the length dimension.

8. The device of claim 1, wherein the MEMS switch further includes:
a second actuation electrode adjacent the first actuation electrode, wherein the second actuation electrode has a first end mechanically coupled to the substrate, a second end mechanically coupled to the substrate, and a central region moveable with respect to the substrate.

9. The device of claim 8, further including a third actuation electrode formed on the substrate opposite the first actuation electrode, a first transmission line contact formed on the surface of the package seal, a second transmission line contact formed on the substrate opposite the first transmission line contact, and a shorting bar mechanically coupled to the central region of the second actuation electrode.

10. The device of claim 9, wherein the first actuation electrode and the second actuation electrode are operative such that the shorting bar can be selectively brought into contact with the first transmission line contact via application of a bias across the first and second actuation electrodes.

11. The device of claim 9, wherein the second actuation electrode is formed between two dielectric mechanical layers.

12. A method for forming a MEMS switch device, comprising:
providing a substrate;
forming a central switch structure on the substrate, the central switch structure including a moveable actuation electrode;
forming a top actuation electrode above the moveable actuation electrode;
forming a package seal layer on the stationary actuation electrode.

13. The method of claim 12, wherein forming the central switch structure includes forming a cantilevered structure comprising two dielectric layers with the moveable actuation electrode formed therebetween.

14. The method of claim 12, further comprising:
forming a bottom actuation electrode and a bottom transmission line contact on the substrate;
forming a first sacrificial layer one the bottom actuation electrode and the bottom transmission line contact;
forming a top transmission line contact adjacent the top actuation electrode;
forming a second sacrificial layer on the central switch structure;
forming the top actuation electrode and a top transmission line contact on the second sacrificial layer;
forming a first portion of the package seal layer on the top actuation electrode and the top transmission line contact; and
removing the first sacrificial layer and the second sacrificial layer.

15. The method of claim 14, further including forming a second portion of the package seal layer after removing the first sacrificial layer and the second sacrificial layer.

16. A MEMS switch comprising:
a substrate having a bottom transmission line contact and a bottom activation electrode;
a package seal coupled to the substrate and having a top transmission line contact and a top activation electrode;
a central switch structure provided between the substrate and the package seal, wherein the central switch includes a moveable activation electrode and a moveable transmission line contact, and wherein the central switch structure is configured to have a first throw mode and a second throw mode, the first throw mode corresponding to electrical contact between the moveable activation electrode and the first transmission line contact, and the second throw mode corresponding to electrical contact between the moveable activation electrode and the second transmission line contact.

17. The switch of claim 16, wherein the top actuation electrode and the bottom actuation electrode are operative in a push-pull manner with respect to the moveable actuation electrode such that the central switch structure can be selectively placed in the first throw mode and the second throw mode via application of a bias to the top and bottom actuation electrodes.

18. The switch of claim 16, wherein the central switch structure includes at least one dielectric layer mechanically coupled to the moveable actuation electrode.

19. The switch of claim 16, wherein the central switch structure is a cantilevered structure mechanically coupled to the substrate.

20. The switch of claim 16, wherein the central switch structure includes a central moveable region and at least two peripheral regions mechanically coupled to the substrate.
